(19) United States
(12) Patent Application Publication
(10) Pub. No.: US 2009/0000377 A1
(43) Pub. Date: Jan. 1, 2009

(54) Brain impact measurement system

(76) Inventors: J. Clay Shipps, Baltimore, MS (US); Hikmet Andic, Baltimore, MD (US); Jesse Bonfeld, Forest Lakes, AZ (US)

Correspondence Address: Goodwin Procter LLP;Attn: Patent Administrator, 135 Commonwealth Drive, Menlo Park, CA, 94025-1105, US

(21) Appl. No.: 12/163,395

(22) Filed: Jun. 27, 2008

Related U.S. Application Data
(60) Provisional application No. 60/947,234, filed on Jun. 29, 2007.

(51) Int. Cl. G01P 15/00

(52) U.S. Cl. 73/514.16

(57) ABSTRACT

A brain and/or skull impact measurement system has a body mounted impact device. The body mounted impact device includes a tri-axial accelerometer configured to measure impacts to an individual's body where the sensor produces impact data in response to the impact. A reader is provided with a data processor and a transmitter/receiver that receives the impact data. The reader is coupled to the body mounted impact device and can be a handheld device.

### CROSS-REFERENCE TO RELATED APPLICATIONS

This application claims the benefit of U.S. Ser. No. 60/947,234, filed Jun. 29, 2007, which application is fully incorporated herein by reference.

### BACKGROUND OF THE INVENTION

1. Field of the Invention

The present invention is directed to systems for measuring impacts to the brain and/or skull, and more particularly to systems that measure impacts to the brain and/or skull that use an accelerometer to sense brain and/or skull impact.

2. Description of the Related Art

There is a concern in various activities, including but not limited to contact sports and other activities, of brain and/or skull injury due to impact to the head. During such physical activity, the head or other body part of the individual, is often subjected to direct contact to the head which results in impact to the brain and/or skull of the individual as well as movement of the head or body part itself.

Much remains unknown about the response of the brain and/or skull to head accelerations in the linear and rotational directions and even less about the correspondence between specific impact forces and injury, particularly with respect to injuries caused by repeated exposure to impact forces of a lower level than those that result in a catastrophic injury or fatality. Almost all of what is known is derived from animal studies, studies of cadavers under specific directional and predictable forces (i.e. a head-on collision test), from crash dummies, from human volunteers in well-defined but limited impact exposures or from other simplistic mechanical models. The conventional application of known forces and/or measurement of forces applied to animals, cadavers, crash dummies, and human volunteers limit our knowledge of a relationship between forces applied to a living human head and resultant severe and catastrophic brain and/or skull injury.

The concern for brain and/or skull related injuries is higher than ever. The Center for Disease Control and Prevention estimates that the incidence of sports and other activities related mild traumatic brain and/or skull injury (MTBI) approaches 300,000 annually in the United States. Approximately ⅓ of these injuries occur in football. MTBI is a major source of lost player time. Head injuries accounted for 13.3% of all football injuries to boys and 4.4% of all soccer injuries to both boys and girls in a large study of high school sports injuries. Approximately 62,800 MTBI cases occur annually among high school varsity athletes, with football accounting for about 63% of cases. Concussions in hockey affect 10% of the athletes and make up 12%-14% of all injuries.

For example, a typical range of 4-6 concussions per year in a football team of 90 players (7%), and 6 per year from a hockey team with 28 players (21%) is not uncommon. In rugby, concussion can affect as many as 40% of players on a team each year. Concussions, particularly when repeated multiple times, significantly threaten the long-term health of the athlete. The health care costs associated with MTBI in sports and other activities are estimated to be in the hundreds of millions annually. The National Center for Injury Prevention and Control considers sports-related traumatic brain and/or skull injury (mild and severe) an important public health problem because of the high incidence of these injuries, the relative youth of those being injured with possible long term disability, and the danger of cumulative effects from repeat incidences.

Athletes who suffer head impacts during a practice or game situation often find it difficult to assess the severity of the blow. Physicians, trainers, and coaches utilize standard neurological examinations and cognitive questioning to determine the relative severity of the impact and its effect on the athlete. Return to play decisions can be strongly influenced by parents and coaches who want a star player back on the field. Subsequent impacts following an initial concussion (MTBI) may be 4-6 times more likely to result in a second, often more severe, brain and/or skull injury. Significant advances in the diagnosis, categorization, and post-injury management of concussions have led to the development of the Standardized Assessment of Concussion (SAC), which includes guidelines for on-field assessment and return to sport criteria. Yet there are no objective biomechanical measures directly related to the impact used for diagnostic purposes. Critical clinical decisions are often made on the field immediately following the impact event, including whether an athlete can continue playing. Data from the actual event would provide additional objective data to augment psychometric measures currently used by the on-site medical practitioner.

Brain and/or skull injury following impact occurs at the tissue and cellular level, and is both complex and not fully understood. Increased brain tissue strain, pressure waves, and pressure gradients within the skull have been linked with specific brain injury mechanisms. Linear and rotational head acceleration are input conditions during an impact. Both direct and inertial (i.e. whiplash) loading of the head result in linear and rotational head acceleration. Head acceleration induces strain patterns in brain tissue, which may cause injury. There is significant controversy regarding what biomechanical information is required to predict the likelihood and severity of MTBI. Direct measurement of brain and/or skull dynamics during impact is extremely difficult in humans.

Head acceleration, on the other hand, can be more readily measured; its relationship to severe brain and/or skull injury has been postulated and tested for more than 50 years. Both linear and rotational acceleration of the head play an important role in producing diffuse injuries to the brain and/or skull. The relative contributions of these accelerations to specific injury mechanisms have not been conclusively established. The numerous mechanisms theorized to result in brain and/or skull injury have been evaluated in cadaveric and animal models, surrogate models, and computer models. Prospective clinical studies combining head impact biomechanics and clinical outcomes have been strongly urged. Validation of the various hypotheses and models linking tissue and cellular level parameters with MTBI in sports and other activates requires field data that directly correlates specific kinematic inputs with post-impact trauma in humans.

Conventional devices have employed testing approaches which do not relate to devices which can be worn by living human beings, such as the use of dummies. When studying impact with dummies, they are typically secured to sleds with a known acceleration and impact velocity. The dummy head then impacts with a target, and the accelerations experienced by the head are recorded. Impact studies using cadavers are performed for determining the impact forces and pressures which cause skull fractures and catastrophic brain and/or skull injury.

There is a critical lack of information about what motions and impact forces lead to MTBI in sports and other activities. Previous research on football helmet impacts in actual game situations yielded helmet impact magnitudes as high as 530 g's for a duration of 60 msec and >1000 g's for unknown durations with no known MTBI. Accelerometers were held firmly to the head via the suspension mechanism in the helmet and with Velcro straps.

In view of the foregoing, there is a demand for a head acceleration sensing system that can be manufactured and installed at very low cost to permit widespread utilization. Further, there is a demand for a system and method for measuring the linear and rotational acceleration of a body part that is easy to install and comfortable for the individual to wear. There is also a desire to provide a low-cost system and method that can record and accurately estimate linear and rotational acceleration of a body part.

### SUMMARY OF THE INVENTION

An object of the present invention is to provide an improved brain and/or skull impact measurement system.

Another object of the present invention is to provide a brain and/or skull impact measurement system that has a tri-axial accelerometer.

A further object of the present invention is to provide a brain and/or skull impact measurement system that can measure impact forces of at least 10's of g's.

Yet another object of the present invention is to provide a brain and/or skull impact measurement system that can measure linear and rotation acceleration of a body part.

Still a further object of the present invention is to provide a brain and/or skull impact measurement system that includes a body mount impact device sized to be positioned in an ear canal.

These and other objects of the present invention are achieved in a brain and/or skull impact measurement system with a body mounted impact device. The body mounted impact device includes a tri-axial accelerometer configured to measure impacts to an individual's body where the sensor produces impact data in response to the impact. A reader is provided with a data processor and a transmitter/receiver that receives the impact data. The reader is coupled to the body mounted impact device and can be a handheld device.

In another embodiment of the present invention, a brain and/or skull impact measurement system has a body mounted impact device includes an acceleration sensor configured to measure impacts to an individual's body where the sensor produces impact data in response to the impact. A reader is provided with a data processor and a transmitter/receiver that receives the impact data. The reader is coupled to the body mounted impact device and can be a handheld device.

### BRIEF DESCRIPTION OF THE DRAWINGS

FIG. 1 is a schematic diagram of one embodiment of body mounted device of the brain and/or skull impact measurement system.

FIG. 2 is a schematic diagram of one embodiment of a PDA that can be coupled to the body mounted device of FIG. 1.

### DETAILED DESCRIPTION OF THE PREFERRED EMBODIMENTS

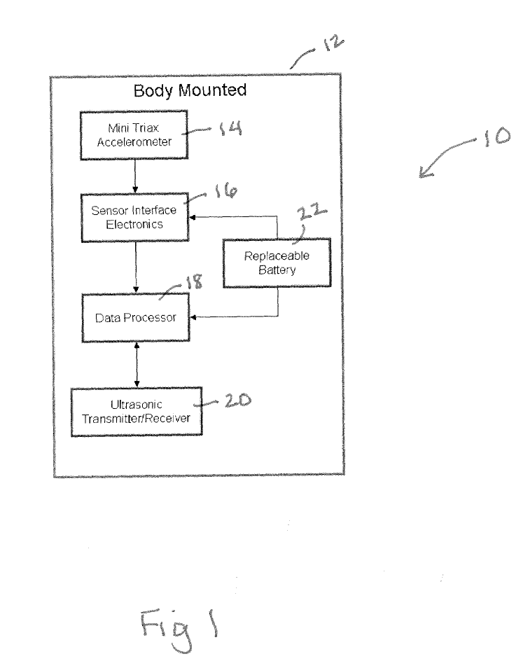

In one embodiment of the present invention, illustrated in FIG. 1, a brain and/or skull impact measurement system 10 is provided that includes a body mounted impact device 12 that includes a sensor 14 configured to measure impacts to an individual's body. The sensor 14 produces impact data in response to the impact. In one embodiment, the system 10 includes sensor interface electronics 16, a data processor 18, an transmitter/receiver 20 and an energy source 22 which can be a battery. The present invention is any profession or activity where it is either suggested or required that an individual wears a helmet or some type of device to protect the head from impact by an external force or device. By way of illustration, and without limitation, this can include, construction workers, miners, firefighters, motorsport racers, electrical workers, members of the armed forces, steelworkers, oilfield or refinery workers, chemical plant workers, workers in any industrial environment, and the like. Additionally, the present invention is applicable for individuals participating in a variety of recreation activities, including but not limited to, bicycling, skiing, snowboarding, surfing, water skiing, hiking, recreational motorcycle or ATV riding, mountain climbing, baseball, softball, equestrian events, skydiving, and the like.

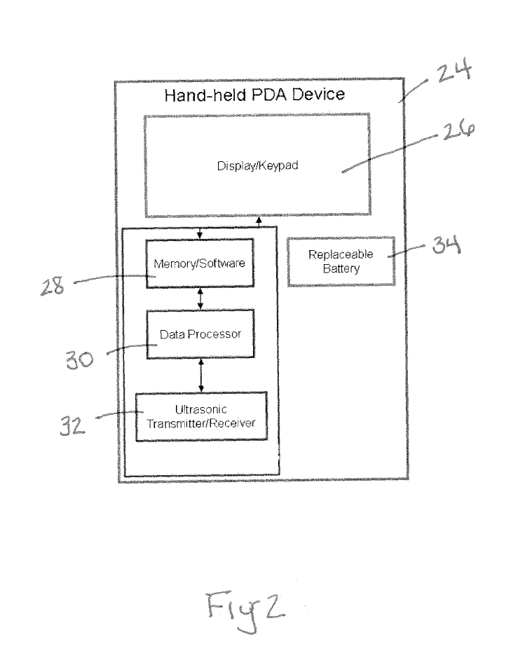

As shown in FIG. 2, a reader 24 is also provided. The reader can be a hand-held PDA. The reader 24 can include a display/keypad 26, memory/software 28, data processor 30, transmitter/receiver 32 and an energy source 34 such as a battery.

The body mounted device of the system 10 will ideally be located as closely as possible to the individual's brain and/or skull so that the true impact to that portion of the body is measured. If the device 12 is not closely coupled to the brain and/or skull a transfer function can be utilized to estimate the impact to the brain and/or skull as a function of the impact measured at another location.

In one embodiment, the sensor is a miniature tri-axial accelerometer 14 that is MEMS device with dimensions on the order of 1-2 millimeters on all sides. The accelerometer 14 can measure g forces on the order of 10s of g's in each of three directions (X, Y, Z). The accelerometer 14 requires power and a small amount of electronics including an amplifier and a flex circuit that allows it to interface with a logic device such as a micro-controller, DSP, FPGA, and the like. The data processor may or may not have built in Analog-to-Digital conversion which will convert the analog signals emanating from the X, Y, and Z channels of the accelerometer 14 (as a result of an impact) to digital signals. The digital signals are scaled based upon the sensitivity of the miniature accelerometer 14 and converted to a g level. The g levels of different impacts, including but not limited to an explosion, fall, vehicular wreck and the like, over time are stored in the memory section of the data processor or in an external memory chip. Each impact measurement is time and date stamped as well as coded with an individual's identification number if required. Each system 10 can store a unique number assigned to each person that has to be monitored. As a non-limiting example, the unique number can be a soldier's identification number, social security, and the like. The unique identifier is forever attached to the individual for medical use.

The information stored in the memory of the micro-controller is downloaded via an ultrasonic transmitter/receiver. AS a non-limiting example, the information stored can be impact measurements that are date and time stamped and accumulated over a specified time period. This device will have a natural resonance in the ultrasonic frequency range (greater than 20 kHz) and is excited by a low level voltage signal at the transmitter/receiver's resonance. Operating at resonance allows the transmitter/receiver to generate a large acoustic signal with very little power input. At resonance, the impedance or resistance of a device is at its lowest which means that the power into that device, Power=Current²×Resistance, is the lowest. The system of the present invention uses very little when it is battery operated. The method for transmitting and receiving the stored information is done using standard modulation schemes such as amplitude-shift keying, phase-shift keying and alike. Ultrasonic technology was chosen for various reasons, such as its high directivity and low “radiation”, therefore providing a low signature, low power requirement etc. The communication protocol can include a secure (possibly encrypted) algorithm. This prevents non-authorized transmit/receive activities.

The entire body mounted device is small enough to be placed in an earplug that is mounted deep within an individual's ear. This is one embodiment of the body mounted device 12 of the system 10. Other means would be to embed the device in a patch worn on the skin at an appropriate location to accurately measure the impact to the brain and/or skull. Other embodiments of the body mounted device include embedding the system on a helmet, on goggles, under the skin, in a false filling in a tooth, etc.

Different embodiments of the components of the body mounted device can be envisioned. For instance, the battery can be rechargeable and remain in place as opposed to being replaceable. The mini-triaxial accelerometer 14 could also be a sensor suite that includes an over-pressure sensor and a temperature sensor as well as the accelerometer 14. It is possible that the overpressure sensor by itself is one embodiment. From a transmission/receive point of view different approaches could be used to meet that need such as RF, optical, IR, audio, as well as directly connecting the body mounted device 12 to the hand held device 24 via wires and a connector or a station in which the body mounted device 12 is plugged into to download the information.

In another embodiment of the present invention, the data processor is separated from a MEMS accelerometer 14 that is located in an earplug. This can be accomplished by routing wires from the earplug device to another body mounted device located on the individual. This other body mounted device can house the data processor and communicate to the hand held device 24 via one of the transmission devices listed above or by direct connection using wires.

The hand held device 24 of the reader can be comprised of three parts; a handheld computer, an interface card and a Graphical User Interface (GUI) 26. The handheld computer 24 can be either a commercial off the shelf PDA (personal digital assistant) or a rugged CDA (commander's digital assistant). PDA's and CDA's have built-in extension ports that enable them to interface with custom data acquisition card, communication cards, etc. An interface card can include the necessary ultrasonic transmitter/receiver 32, electronics 30 and software 28 to communicate with the PDA 24. The GUI residing 26 on the PDA 24 can be specifically designed to query, and record data from the body mounted device 12. The GUI 26 allows a medical person to have control of the data transfer from the body mounted device 12 and then to log and view the data in order to make decisions on the health care for the individual. The PDA 24 can be battery operated, include a screen and a keypad 26 to initiate commands and display results. The PDA 24 also has a large amount of internal memory that can store data from body mounted device 12.

Different embodiments of the hand held device 24 can be envisioned. For instance, the device 24 may be a field deployable lap-top computer or a device that is build for this specific purpose without taking advantage of Commercial off the shelf products. From a transmission/receive point of view different approaches could be used to meet that need such as RF, optical, IR, audio, as well as directly connecting the body mounted device to the hand held device via wires and a connector or a station in which the body mounted device 12 is plugged into to download the information.

### Method of Operation

The body mounted device 12 can be located on an individual before a specific situation which could result in head trauma. The trauma is detected using previously defined events such as g level above a certain threshold. If head trauma occurs, the event or events is stored in the memory on the body mounted device. After the event, the individual is approached by medical personnel with the hand held device 24 of the system 10. The medic will instruct the hand held device via the keypad or the screen to interrogate the body mounted device via an ultrasonic transmission from the hand held transmitter/receiver. The body mounted device will not respond or transmit data unless it receives a secure ultrasonic transmission at the ultrasonic frequency that it is tuned too. There is an allowance for frequency drift due to environmental factors but in general the range is small. Once the body mounted device receives the ultrasonic transmission, it will initiate the data recovery and transmit it to the hand held transmitter/receiver. The hand held unit will then store the information and display the events in terms of the magnitude and direction of the impact. The magnitude and direction of the impact can be broken down into its X, Y, and Z components. By way of illustration, a treating medical personal wants to know the location of the brain and/or skull that was hit the hardest. This provides information relative to likely physical results resulting from the impact. Additionally, the system of the present invention can be utilized to start a very large database that indicates what symptoms occur after certain areas of the brain and/or skull are impacted. Medical personal may also want to look at the results of one large impact compared to several small impacts, and so forth. Other items such as time and date of impact, and individual identification number can also be displayed.

Basic person triage could also be done at that level. The PDA will respond with a color coded message such as:

“Green”: No concerning events.

“Orange”: Low level “g” events, should be checked by a medic at a later date.

“Red”: High “g” level event recorded. Immediate attention required.

The remaining of the data will then be uploaded to a central database, traceable to a specific person. Such a database and historical data building will enable professionals in the medical field to monitor high “g” level events and repeated low “g” level events on a person.

### Ultrasonic Transmission Methodology

As stated earlier, ultrasonics can be used as a transmission means between the body mounted 12 and hand held device 24 for many reasons. Those reasons are listed below but not limited to the following:

Human hearing cannot perceive ultrasonic frequencies (above 20 kHz) so if the device 12 were located in an earplug or near the ear, it would not be perceived by the individual.

### Ultrasonic Devices are Inexpensive and Easy to Make.

Most ultrasonic devices and have very high “Q”. This means that the resonance of the device is very sharp and well defined. This means that it is extremely efficient at its resonance and requires very little power to transmit or receive at that frequency.

The ultrasonic background noise levels are very low in most environments so the probability is very low that the body mounted device is initiated by spurious ultrasonic noise.

An additional reason for using ultrasonics is the very short transmission path. Ultrasonic energy is highly attenuated in air which results in very low transmission distances. Therefore spurious ultrasonic energy would have to be at very high levels to initiate the body mounted device 12 or the wearer of the device 12 would have to be in very close proximity to the ultrasonic noise. For this reason the hand held device 24 of the system 10 should be held very close (1 to 3 feet) to the body mounted device 12 of the system to initiate data recovery. This will also help to prevent initiating the body mounted devices 12 of several individuals who may be wearing the device and be in close proximity to the individual of interest.

Expected variations or differences in the results are contemplated in accordance with the objects and practices of the present invention. It is intended, therefore, that the invention be defined by the scope of the claims which follow and that such claims be interpreted as broadly as is reasonable.

What is claimed is:

1. A brain and/or skull impact measurement system, comprising:
a body mounted impact device that includes a triaxial accelerometer configured to measure impacts to an individual's body, the sensor producing impact data in response to the impact; and
a reader with a data processor with a transmitter/receiver that receives the impact data, the reader being coupled to the body mounted impact device, wherein the reader can be a handheld device.

2. The system of claim 1, wherein the reader visually displays the impact data.

3. The system of claim 1, wherein the body mounted impact device includes sensor interface electronics, a data processor, a transmitter/receiver and a power source.

4. The system of claim 1, wherein the power source is a battery.

5. The system of claim 4, wherein the battery is a rechargeable battery.

6. The system of claim 1, wherein the body mounted impact device is located close to the individual's brain and/or skull to provide for measurement of an impact to the head.

7. The system of claim 1, further comprising:
a transfer function that estimates an impact to the brain and/or skull as a function of an impact measured at another location of the individual's body.

8. The system of claim 1, wherein the sensor has dimensions on the order of about 1-2 millimeters on all sides.

9. The system of claim 1, wherein the sensor is configured to measure forces of at least 10s of g's in each of three directions (X, Y, Z).

10. The system of claim 1, wherein the sensor is configured to measure forces of at least 150 g's in each of three directions (X, Y, Z).

11. The system of claim 1, wherein the sensor includes electronics that provide for interfacing with a logic device.

12. The system of claim 11, wherein the logic device is selected from at least one of, a micro-controller, DSP and an FPGA.

13. The system of claim 1, wherein a data processor converts analog signals emanating from X, Y, and Z channels of the accelerometer resulting from an impact to digital signals.

14. The system of claim 13, wherein the digital signals are scaled based on a sensitivity of the accelerometer and convert the digital signals to a g level.

15. The system of claim 14, wherein g levels of different impacts over time are stored in a memory section of the data processor or in an external memory chip.

16. The system of claim 1, wherein each of an impact measurement is time and date stamped, and coded with an individual's identification number.

17. The system of claim 1, wherein each system stores a unique number assigned to each individual that has to be monitored.

18. The system of claim 1, wherein the reader includes a micro-controller with memory, and the transmitter/receiver is an ultrasonic transmitter/receiver.

19. The system of claim 18, wherein the system has a natural resonance in an ultrasonic frequency range that is excited by a low level voltage signal at a resonance of the transmitter/receiver.

20. The system of claim 19, wherein the ultrasonic frequency range is greater than 20 kHz.

21. The system of claim 1, wherein the system uses a communication protocol with a secure algorithm.

22. The system of claim 1, wherein the body mounted device is sized to be placed in an earplug.

23. The system of claim 1, wherein the body mounted device is in a patch worn on a skin surface.

24. The system of claim 1, wherein the body mounted device is embedded at one of, a helmet, goggles, under the skin, and in a false filling in a tooth.

25. The system of claim 1, wherein transmission or receive from the body mounted impact device to the reader is with at least one of, RF, optical, IR, audio, directly connecting the body mounted impact device to the reader hand held device via wires and a connector or a station in which the body mounted device was plugged into to download the information.

26. The system of claim 1, wherein the hand held device includes, a handheld computer, an interface card and a Graphical User Interface (GUI).

27. The system of claim 26, wherein the handheld computer includes one or more built-in extension ports that that provide interface with a data acquisition card or a communication card.

28. The system of claim 26, wherein the GUI is configured to query and record date from the body mounted impact device.

29. The system of claim 26, wherein the hand held device is a field deployable computer.

30. The system of claim 11 wherein the body impact results in trauma to the individual.

31. The system of claim 30, wherein the impact is detected by the sensor and the trauma is determined in response to one or more previously defined events.

32. The system of claim 31, wherein the previously defined event is a g level above a threshold.

33. The system of claim 1, wherein in response to the impact the hand held device interrogates the body mounted device with ultrasonic transmission from a transmitter/receiver of the hand held device.

34. The system of claim 1, wherein the body mounted device does not respond or transmit data unless it receives a secure ultrasonic transmission at an ultrasonic frequency that it is tuned too.

35. The system of claim 34, wherein after the body mounted device receives the ultrasonic transmission, the body mounted device initiates a data recovery and transmits the data recovery to the transmitter/receiver.

36. The system of claim 34, where the hand held device stores information from the data recover and displays events in terms of magnitude and direction of the impact.

37. The system of claim 36, wherein the hand held device further displays at least one of, time and date of impact, and individual identification number.

38. The system of claim 33, wherein a portion of data from the data recovery is loaded to a central database.

39. A brain and/or skull impact measurement system, comprising:
a body mounted impact device that includes an acceleration sensor configured to measure impacts to an individual's body, the sensor producing impact data in response to the impact; and
a reader with a data processor with a transmitter/receiver that receives the impact data, the reader being coupled to the body mounted impact device, wherein the reader can be a handheld device.

40. The system of claim 39, wherein the acceleration sensor includes an over-pressure sensor and a temperature sensor.
